(19) United States
(12) Patent Application Publication
(10) Pub. No.: US 2022/0026240 A1
(43) Pub. Date: Jan. 27, 2022

(54) SENSOR UNIT HAVING AT LEAST ONE GEARWHEEL FORMED FROM A PRINTED CIRCUIT BOARD

(71) Applicants: thyssenkrupp Presta AG, Eschen (LI); thyssenkrupp AG, Essen (DE)

(72) Inventors: Robert GALEHR, Schaanwald (LI); Gergely RACZ, Budapest (HU); Sedat SEN, Heerbrugg (CH)

(73) Assignees: thyssenkrupp Presta AG, Eschen (LI); thyssenkrupp AG, Essen (DE)

(21) Appl. No.: 17/299,535

(22) PCT Filed: Dec. 10, 2019
(86) PCT No.: PCT/EP2019/084409

§ 371 Date: Jun. 3, 2021

(51) Int. Cl. G01D 5/04; G01D 5/20

(52) U.S. Cl. CPC G01D 5/04; G01D 5/202

(57) ABSTRACT

A sensor unit for measuring a rotational state of a shaft may include a transmission. The transmission may be connected to or configured to connect to the shaft. The transmission may have at least two transmission elements that are in engagement with one another via a toothing. At least one of the at least two transmission elements is a gearwheel whose rotation about a rotational axis is detected by a sensor. The at least one gearwheel and the toothing arrangement of the at least one gearwheel may be formed by a printed circuit board. A track may be arranged on an end side of the gearwheel that faces the sensor, and the sensor may scan the track to measure a rotational state of the gearwheel about the rotational axis.

The present invention relates to a sensor unit having the features of the preamble of claim 1, in particular to a sensor unit for determining a rotational state of a shaft or to a motor vehicle steering system having such a sensor unit.

Such sensor units can be applied, for example, to determine a rotational angle, a torque, a rotational speed, a rotational acceleration, a rotational position and/or a direction of rotation. Such sensors can be used in motor vehicles, inter alia, as steering angle sensors. These measure the steering angle of the steering wheel of a motor vehicle. Rotational angle sensors are also used in torque sensors. For both tasks, sensors are used in which a component is coupled to a shaft and a sensor senses the relative rotation of the component with respect to the sensor.

Laid-open patent application EP 1 607 720 A2 discloses an absolute steering angle sensor for determining the absolute steering angle of a motor vehicle. The steering angle sensor has a drive ring which can be rotationally coupled to a steering shaft and which is in engagement with a rotor via a toothing arrangement and drives said rotor. The rotor has on one side a fixedly arranged magnetic arrangement. The rotation of the rotor or the magnetic arrangement is sensed with magnetic field sensors which are arranged on a circuit board. This solution proves disadvantageous as result of the high number of components which are required for the steering angle sensor.

It is therefore an object of the present invention to specify a sensor unit which requires fewer components, which permits a saving in terms of costs and installation space.

This object is achieved by a sensor unit having the features of claim 1. Advantageous developments emerge from the dependent claims.

Accordingly a sensor unit for measuring a rotational state of a shaft is provided, having a transmission which is connected to the shaft, wherein the transmission has at least two transmission elements which are in engagement with one another via a toothing and wherein at least one of the at least two transmission elements is a gearwheel whose rotation about a rotational axis is detected by the sensor unit, and wherein the at least one gearwheel and the toothing of the at least one gearwheel are formed by a printed circuit board. Since the toothing is embodied one piece with the gearwheel, components and/or further processing steps can be eliminated. As a result the costs of the sensor unit can be lowered. It is also conceivable and possible for the transmission elements to be embodied as drivers which are in engagement with one another at least in a temporarily positively locking fashion.

A track for a surface structure is preferably applied to an end side, facing the sensor unit, of the at least one gearwheel, wherein the sensor unit is configured to scan the track in order to measure a rotational state, preferably a rotational angle of the at least one gear wheel about its rotational axis. At least the gearwheel or the toothing arrangement preferably has a surface structure. The track and/or the surface structure are/is sensed inductively, capacitively, optically or acoustically. The track and/or the surface structure are/is advantageously embodied in such a way that the latter is formed by projections and depressions. The gearwheel or the toothing is preferably provided with a coating which contains at least MoS₂, PTFE, graphite or PE-UHMW. In one preferred embodiment, the at least two transmission elements comprise two gearwheels which each have an electrically conductive track on an end side facing the sensor unit, wherein the sensor unit is configured to scan the two tracks inductively in order to measure the rotational state of the shaft. In this context, the two electrically conductive tracks are preferably embodied in a closed on themselves and asymmetrical fashion with respect to a corresponding rotational axis of the gearwheel, in such a way that an absolute angle determination is possible over one rotation of the shaft. The two tracks or the surface structure are preferably formed from copper. Furthermore, it is conceivable and possible that said tracks are formed from aluminum, silver, tin, nickel and/or gold. The sensor unit advantageously comprises coils which can be assigned to the two gearwheels and which are preferably arranged on a common carrier plate. The coils are preferably each part of an oscillatory circuit and generate a high-frequency magnetic field. The tracks are preferably circular and each have a width in the radial direction, in the plane of the end face of the gearwheels, which increases uniformly over a first semicircle along the circumference, and decreases again uniformly over the second semicircle. The rate of increase and decrease of the width is respectively continuous and constant here over the entire circumference. The transmission is preferably a single-stage helical gear unit. The number of teeth of the two gearwheels is preferably different. In this context, the first gearwheel preferably has at least 3 times more teeth than the second gearwheel, more preferably 4 times more teeth than the second gearwheel. One of the gearwheels preferably surrounds the shaft concentrically and is connected thereto in a torque-proof manner.

In one advantageous embodiment, the transmission has a transmission ratio of less than 1.

There can be provision that the teeth of the at least two transmission elements have an involute, epi-/hypocycloid or cylindrical lantern gear toothing. The toothing can be configured in an axis-parallel or in an oblique fashion or as an arcuate toothing. Furthermore, it is conceivable and possible that the teeth are embodied as a Maltese cross.

Furthermore, a corresponding motor vehicle sensor unit and a corresponding motor vehicle steering system sensor unit are provided.

The object is also achieved by a motor vehicle steering system with a sensor unit as described above.

Preferred embodiments of the invention are explained in more detail below with reference to the drawings. Identical and functionally identical components are provided here with the same reference symbols in all the figures. In the drawings:

FIG. 1: shows a schematic illustration of an electromechanical motor vehicle steering system,

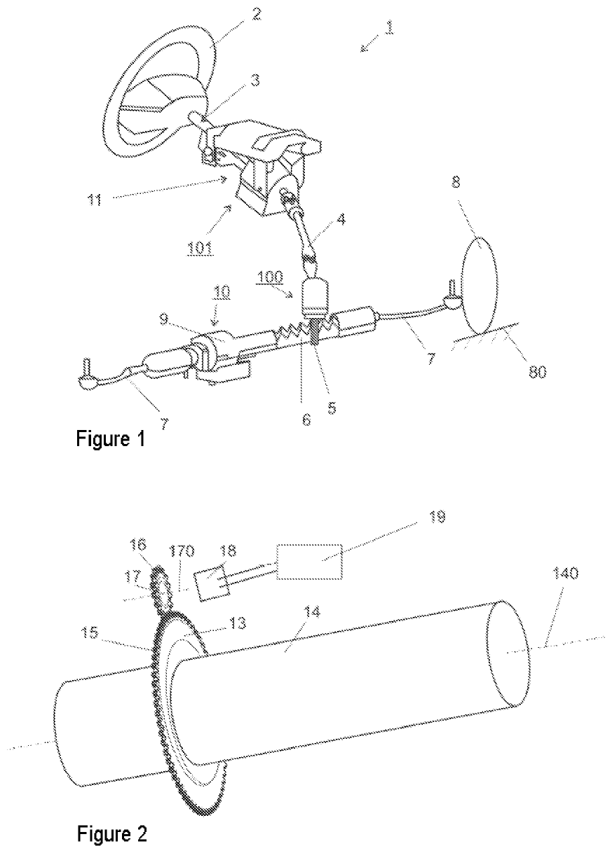

FIG. 2: shows a schematic illustration of a sensor unit,

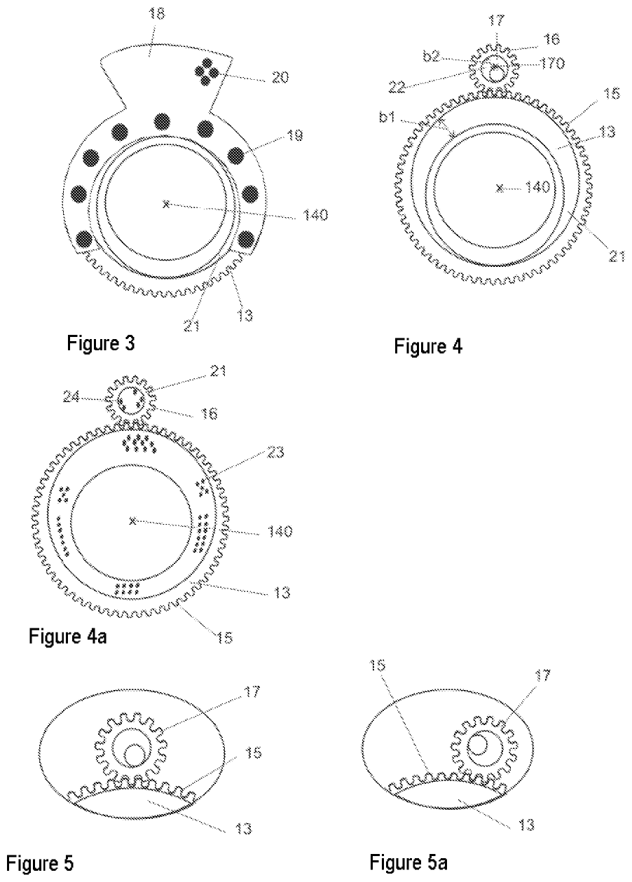

FIG. 3: shows a plan view of the sensor unit without a shaft,

FIG. 4: shows a view of a circuit board of the sensor unit from FIG. 3,

FIG. 4a: shows a view of a circuit board of the sensor unit from FIG. 3 with an additional surface structure,

FIGS. 5, 5a: show detailed views of the engagement between the circuit boards,

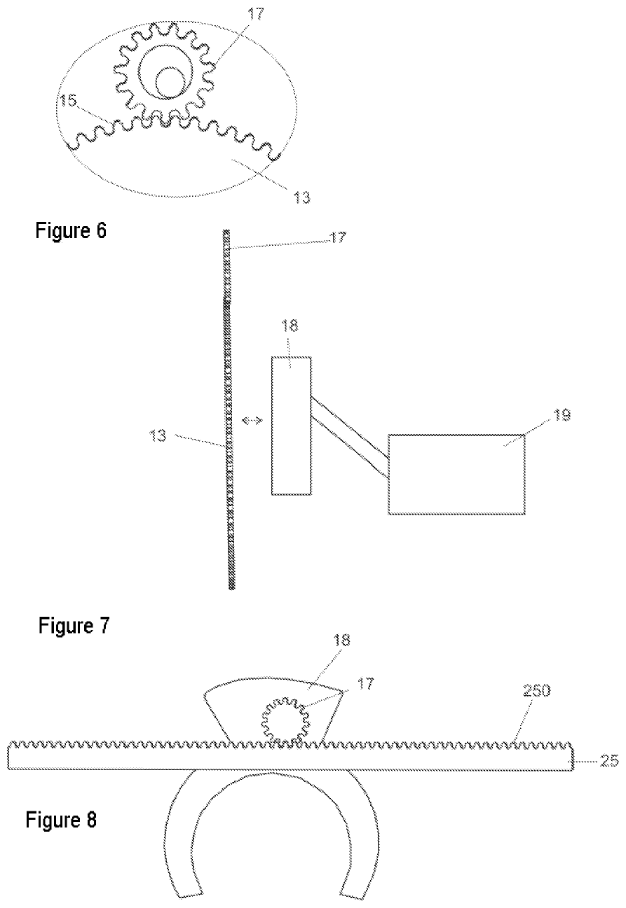

FIG. 6: shows a detailed view of the engagement of two circuit boards with a cylindrical lantern gear toothing arrangement,

FIG. 7: shows a lateral view of the sensor unit, and

FIG. 8: shows a schematic illustration of a steering rack transmission with a toothed circuit board.

FIG. 1 is a schematic illustration of an electromechanical motor vehicle power steering system 1 with a steering wheel 2 which is coupled in a torque-proof manner to an upper steering shaft 3. The driver inputs a corresponding torque as a steering command into the steering shaft 3 via the steering wheel 2. The torque is then transmitted to a steering pinion 5 via the upper steering shaft 3 and the lower steering shaft 4. The pinion 5 meshes in a known fashion with a toothed segment of a steering rack 6. The steering rack 6 is mounted in a displaceable fashion in the direction of its longitudinal axis in a steering housing. At its free end, the steering rack 6 is connected to tie rods 7 via ball and socket joints (not illustrated). The tie rods 7 themselves are connected in a known fashion to in each case one steered wheel 8 of the motor vehicle via steering stub axles. A rotation of the steering wheel 2 brings about, via the connection of the steering shaft 3 and the pinion 5, longitudinal shifting of the steering rack 6 and therefore pivoting of the steered wheels 8. The steered wheels 8 experience, via a roadway 80, a reaction which counteracts the steering movement. In order to pivot the wheels 8, a force is consequently necessary which a corresponding torque makes necessary at the steering wheel 2. An electric motor 9 of a servo unit 10 is provided for assisting the driver during this steering movement. The upper steering shaft 3 and the lower steering shaft 4 are coupled to one another in a rotationally elastic fashion via a torsion bar (not shown). A torque sensor unit 11 senses the rotation of the upper steering shaft 3 with respect to the lower steering shaft 4 as a measure of the torque which is applied manually to the steering shaft 3 or the steering wheel 2. The servo unit 10 provides steering assistance for the driver as a function of the torque measured by the torque sensor unit 11. The servo unit 10 can either be coupled to the here as a power steering assistance device 10, 100, 101. The respective power steering assistance 10, 100, 101 inputs an auxiliary steering torque into the steering rack 6, the steering pinion 5 and/or the steering shaft 3, as result of which the driver is assisted during the steering work. The three different power steering assistance devices 10, 100, 101 which are illustrated in FIG. 1 show alternative positions for their arrangement. Usually just a single position of those shown is occupied by a power steering assistance.

FIG. 2 and FIG. 7 show schematic views of a sensor unit which, in this exemplary embodiment, constitutes a rotational angle sensor unit 12 which can be provided, for example as part of the torque sensor unit 11, for measuring the rotational angle of the steering shaft 3, 4. A first gearwheel 13 is connected in a torque-proof manner to a shaft 14, in particular the steering shaft, and surrounds it concentrically. The first gearwheel 13 has an outwardly directed toothing 15 which is arranged concentrically with respect to the shaft axis 140. This first toothing 15 of the first gearwheel 13 engages in a second rotating, outwardly directed toothing 16 of a second gearwheel 17 which rolls on the first gearwheel 15. The second gearwheel 17 rotates about a second gearwheel axis 170 which is arranged parallel and offset with respect to the shaft axis 140 and is fixed in space. The rotational movement of the shaft 14 is therefore transmitted to the second gearwheel 17. A sensor unit 18 measures the rotations of the first and second gearwheels 13, 17 and passes on the measured signals to a control unit 19 which can determine an absolute rotational angle of the shaft 14 therefrom.

FIG. 3 shows an inductive sensor unit 18 with a first gearwheel 13 which lies below it. The sensor unit 18 comprises a multiplicity of coils which are arranged on a common carrier plate and are divided into two groups; a first group 19 for measuring the rotation of the first gearwheel 13, and a second group 20 for measuring the rotation of the second gearwheel 17. The coils of the first group 19 are arranged spaced apart evenly over a circular sector in the circumferential direction, above the first gearwheel 13. The coils of the second group 20 are distributed in the circumferential direction of the second gearwheel 17 at uniform intervals over an end side of the second gearwheel 17 (not illustrated). The two gearwheels 13, 17 each have an electrically conductive track 21, 22 which moves with respect to the coils 19, 20. The tracks 21, 22 are preferably made of copper. The coils of the first and second groups 19, 20 are each parts of an oscillatory circuit. They generate a high-frequency magnetic field. If the assigned track 21, 22 moves in the respective magnetic fields, a flow of an induction current is initiated owing to the electromagnetic induction. Owing to the mutual inductive coupling, the resonant frequency of the oscillatory circuit changes. If a non-ferrous metal object, such as for example the copper track, approaches, the resonant frequency of the electrical oscillatory circuit increases. The mutual inductive coupling therefore changes if the track 21, 22 moves away over the coils 19, 20. The rotations of the first and second gearwheels 13, 17 can therefore be sensed by means of the sensor unit.

FIG. 4 illustrates in detail the two gearwheels 13, 17 which are in engagement. The tracks of the two gearwheels 21, 22 are closed on themselves and do not have a start or an end. The pattern or the surface structure of the two tracks 21, 22 is embodied in such a way that an absolute angle determination is therefore possible over one rotation of the shaft. It is not embodied concentrically in relation to the respective rotational axis 140, 170 of the gearwheels 14, 17. The tracks 21, 22 are circular and each have a width b1, b2 in the radial direction, in the plane of the end face of the gearwheels, which increases uniformly over a first semicircle along the circumference and decreases again uniformly over the second semicircle. The rate of increase and decrease of the width is respectively continuous and constant here over the entire circumference. The center point of the circle is not identical to the rotational axis of the corresponding gearwheel 140, 170. The number of teeth of the second gearwheel 17 is smaller than the number of teeth of the first gearwheel 13. The number of teeth of the first gearwheel 13 is not an integral multiple of the number of teeth of the second gearwheel 17. In this context, the first gearwheel preferably has at least 3 times more teeth than the second gearwheel, more preferably 4 times more teeth than the second gearwheel. The gearwheels 13, 17, with their outer toothing 15, 16, form the circuit boards. The circuit boards also have at least one of the following components: at least one electrical resistance, at least one capacitor, at least one diode and/or at least one transistor. The toothing arrangement 15, 16 is therefore formed directly by the respective circuit board. Applying a material to the end sides in order to form the toothing is in fact not provided. The two gearwheels 13, 17 are therefore in abutment by means of the circuit boards. The respective track 21, 22, a surface structure 23, 24 or a conductor track is applied to the circuit boards. The circuit board is preferably composed of fiber-reinforced plastic.

FIG. 4a shows that both gearwheels can have, in addition to the track 21, 22, a surface structure 23, 24 by means of which the rotational state of the shaft 14 can be detected more precisely.

As is illustrated in FIGS. 5 and 5a, the small gearwheel 17 rolls on the toothing of the large gearwheel 13 when the shaft rotates. For both of the two gearwheels 13, 17, the track 21, 22 permits an absolute rotational angle measurement over 180°. The rotational angle can be determined absolutely over 360° by combining the two signals. In this context, FIG. 5a shows the rolling of the small gearwheel with respect to the large gearwheel.

FIG. 6 shows a further sensor toothing which is also embodied as a single-stage helical gear unit, wherein the gearwheels 13, 17 are in engagement with one another via a cylindrical lantern gear toothing.

FIG. 8 shows a linear embodiment of the sensor arrangement in the form of a steering rack transmission 25 in which a gearwheel 17 rolls on a toothing 250 of a steering rack 25, and therefore the rotation of the gearwheel 17 can be converted into a linear movement of the steering rack, and vice versa. The sensor unit 18 measures the rotation of the gearwheel 17 here.

The toothing arrangement 15, 16 of the transmissions described above can be configured, for example, as an involute toothing, epi-/hypocycloid toothing or as a cylindrical lantern gear toothing.

In addition to transmissions with a uniform transmission ratio, the gearwheels can also be used in stepping gear arrangements.

1.-13. (canceled)

14. A sensor unit for measuring a rotational state of a shaft, the sensor unit comprising a transmission that is connectable to the shaft, wherein the transmission includes at least two transmission elements that are engaged with one another via a toothing, wherein one of the at least two transmission elements is a gearwheel that includes the toothing, wherein rotation of the gearwheel about a rotational axis is configured to be detected by a sensor, wherein a printed circuit board defines the gearwheel and the toothing of the gearwheel.

15. The sensor unit of claim 14 comprising a track disposed on an end side of the gearwheel that faces the sensor, wherein the sensor is configured to scan the track to measure a rotational state of the gearwheel about the rotational axis.

16. The sensor unit of claim 14 wherein the gearwheel is a first gearwheel, wherein one of the at least two transmission elements is a second gearwheel, wherein each of the first and second gearwheels includes an electrically conductive track on an end side that faces the sensor, wherein the sensor is configured to scan the electrically conductive tracks inductively to measure a rotational state of the shaft.

17. The sensor unit of claim 16 wherein the second gearwheel includes a toothing, wherein a number of teeth on the first gearwheel is different than a number of teeth on the second gearwheel.

18. The sensor unit of claim 16 wherein teeth on the first and second gearwheels have an involute gear toothing.

19. The sensor unit of claim 16 wherein teeth on the first and second gearwheels have an epi-/hypocycloid gear toothing.

20. The sensor unit of claim 16 wherein teeth on the first and second gearwheels have a cylindrical lantern gear toothing.

21. The sensor unit of claim 16 wherein each of the electrically conductive tracks is closed on itself and is arranged asymmetrically relative to the rotational axis of the respective gearwheel to enable an absolute angle determination over one rotation of the shaft.

22. The sensor unit of claim 21 wherein the electrically conductive tracks are comprised of copper.

23. The sensor unit of claim 14 wherein the gearwheel surrounds the shaft concentrically and is connected to the shaft in a torque-proof manner.

24. The sensor unit of claim 14 wherein the transmission has a transmission ratio of less than one.

25. The sensor unit of claim 14 wherein the transmission is configured as a single-stage helical gear unit.

26. A motor vehicle sensor unit comprising the sensor unit of claim 14.

27. A motor vehicle steering system comprising the sensor unit of claim 14.
